(19) United States
(12) Patent Application Publication
(10) Pub. No.: US 2006/0070783 A1
(43) Pub. Date: Apr. 6, 2006

(54) SKID CONTROL TRAINING SYSTEM

(75) Inventor: KAZIMIERZ J. DZIAK, TORONTO (CA)

Correspondence Address: KAZIMIERZ J. DZIAK, 21 THORNDALE AVENUE, TORONTO, ON, M8X 1W8, CA

(73) Assignee: KAZIMIERZ J. DZIAK, TORONTO (CA)

(21) Appl. No.: 10/711,600

(22) Filed: Sep. 28, 2004

(51) Int. Cl. B60P 3/06; B60B 11/10

(52) U.S. Cl. 180/198; 280/767

(57) ABSTRACT

The system of imitating automotive vehicle skidding on a straight or curved part of the track utilizes a front wheel drive vehicle. The front wheels subsystem, operated by driver or an instructor, generates the lateral yaw by selective braking of only one of front wheels. The rear wheels subsystem has three distinct embodiments allowing 360 degrees of lateral movement. The first embodiment replaces both rear wheels with two separate castering assemblies. No stabilizer required. The second and third embodiment is a wide, low floor trailer. Training vehicle rear wheels rest above the road surface, in the cradles on the trailer. Training vehicle is affixed to the trailer by an automotive ball hitch. The system utilizes generally available suitable duty swivels and pneumatic tires. Training vehicle with systems installed is capable of going 50 km/h. Employ the skid control training system in driver training or film and entertainment industry.

### FIELD OF THE INVENTION

Every automobile driver should experience effect skidding has upon ability to control a vehicle. In the popular belief vehicle skidding occurs when a vehicle enters a sharp curve at an excessive rate of speed. It is only a part of the truth. Vehicle skidding can happen on a straight stretch of a road when for example vehicle breaks heavily, hits a sizeable pothole or piece of debris with one of the front wheels, clips a loose shoulder, abruptly changes a traffic line, gets a sudden wind blow from the side, hits a patch of black ice, mud or rain water puddle with one of the front wheels, etc. In order to survive the potentially lethal results of uncontrolled skidding the automobile driver must in the split of a second recognize that the car has just begun skidding and recover it from the skid by using properly all available vehicle controls. This has to be an unconditioned reflex. Unfortunately, people don't have this reflex and must acquire it through hands-on training. Reading about skidding or looking at simulator monitor, being shown vehicle skidding, doe's not give the trainee necessary visceral experience. It takes time at the skid pad to instill skidding reflex, and it has to be refreshed from time to time. Automobile driver should be prepared to recognize a vehicle skid and recover from it before it becomes uncontrollable. Recognizing this need, a few driving schools set up driving improvement programs aimed at giving drivers a vehicle skidding experience. The current state of the art available to the average driver amounts to a high speed/short distance chase at a flooded parking lot. A level asphalt parking lot (preferably painted for lower friction) is sprayed with water or a low friction fluid. To generate enough skidding action the training vehicle must travel at the speed of 50 km/h or more. For such speed even a large parking lot becomes short and risky. The stress put on the vital systems of the training vehicle is large and tires, brakes, steering, rear axle, transmission, etc. wear out quickly. Training vehicle maintenance and large, level, paved skid pad are expensive. Such an operation is noisy (screeching tires) and requires long setup time (watering the surface). High price and scarce locations make this kind of training unavailable to most of automobile drivers.

### DESCRIPTION OF THE PRIOR ART

The demand for a satisfactory skid control training system grows with more vehicles and drivers on our roads. There were several attempts to solve technical problems relevant to the matter on hand.
U.S. Pat. No. 4,998,594 calls for a frame with four caster wheels affixed to it. The frame is wider than a vehicle installed on the top of the said frame. Casters tilt forward or rearward and can lift or lower vehicle axles upon which casters are installed. This action creates various degree of contact between vehicle tires and the road, and simulates reduced traction conditions.
U.S. Pat. No. 4,700,798 discloses very similar frame with casters mounted under the training vehicle solution. Upward and downward movement of swivel wheels is performed by the set of hydraulic cylinders for a change. The degree of experience both of these devices can provide is limited and their price tag is high. Many moving parts and massiveness of both devices makes them expensive to manufacture. Size and weight of assembled apparatus reduces portability and possibility of being shared by driver training establishments, making the apparatus too expensive to be popular for traffic safety education.
U.S. Pat. No. 5,626,362 and U.S. Pat. No. 5,743,562 refer to the same technical solution. Front wheel drive car is specified as the training vehicle. In the preferred embodiment both rear wheels are replaced with two separate units affixed onto brake drums and affixed rigidly to vehicle frame with a stabilizer bracket. Each side apparatus unit contains only one swiveling caster. This is highly unstable by its nature and requires strong stabilizer bracket. The alternate method disclosed in this patent shows one or two swiveling units placed behind the training vehicle and affixed to one or two trailer hitches installed under the training vehicle. It is said that vehicle rear wheels do not touch the road and essentially the whole vehicle rides on two front wheels and one or two swiveling units placed well behind vehicle's rear bumper. Such a vehicle would require a heavy body reinforcement to accommodate higher bending torque and body shearing stress associated with significant extension of the vehicle wheelbase. This eliminates easy portability of the device to another not specially prepared vehicle. Vehicle with the alternate device is hard to maneuver and requires more space because of long wheelbase. One of the highlights of the discussed U.S. Pat. No. 5,626,362 is the remote control lock of the swiveling action. Wheel traction crossing from full traction to skidding is a continuous process and driver should learn to feel this delicate distinction. Generating the skid in the on/off manner does not let the driver feel when the skidding action should begin. Disclosed prior art apparatus can generate the skidding action only, when the vehicle is driven along a curve.

None of prior art inventions addressed the problem of swivel wheels wobbling. Wobbling is a natural result of the free swiveling action of a wheel being dragged on a link with one degree of freedom. Threshold value speed for wobbling to occur will vary with the construction details, but as the rule of thumb the wheel wobbling has to be considered with vehicle speeds over 15 km/h.

### SUMMARY OF THE INVENTION

The main object of this invention is to provide safe, reliable and inexpensive simulator for all aspects of skid control hands-on training. The present invention utilizes the front wheel drive vehicle only. The skid control training system has two distinct subsystems namely:
The front wheels selective braking subsystem exercises control over behavior of the front wheels of the vehicle and has the capability of inducing the lateral movement of the training vehicle.
The rear wheels skid imitating subsystem keeps vehicle rear wheels up and away from the road surface throughout the entire training session and enables lateral movement of the rear of the training vehicle (imitating skidding).

The split of the functions between front and rear axles is distinctive over any aforementioned patents. In present invention the skidding action can be induced by the instructor on the straight part of the track, by the instructor on the curved part of the track, or by the training vehicle being driven at excessive rate of speed on the curved part of the track. Being able to induce the skid on the straight part of the track is superior to skidding in the curve only. To induce skidding, the driving instructor makes two decisions:
He decides the direction of the yaw by moving and holding the selection switch to one side. For example instructor holds the switch to the left and the left inline cut off valve is activated. The cut off valve closes the left front brake line. The vehicle is still going straight forward, but the stage is set for a skid.
The instructor makes the second decision about the timing and severity of the yaw. He activates and releases the auxiliary activator of the vehicle brakes located for example in the front passenger floor area and connected to the driver's brake pedal. A short braking action occurs in both rear wheels of the vehicle and in the right front wheel of the vehicle. Braking action in the rear wheels does not affect vehicle's movement because rear wheels do not come in contact with the road surface. Braking action in the right front wheel causes asymmetric braking and the vehicle makes the yaw to the left.
In an unaided training option, for example an electronic device can be added. Said electronic device generates random closure of only one of two front brakes cut off valves at any given time. By activating and releasing the brake pedal, the driver induces a skid in an unexpected direction and has to recover it. An unaided option can be available for well-seasoned drivers only and sets present invention apart from any of aforementioned patents.

The second function of the skid control training system is to enable the lateral movement of the rear part of the training vehicle (skid imitating). Present invention features three distinctive embodiments using a number of common elements and ideas.
Embodiment No. 1 replaces both rear wheels of a front wheel drive vehicle with two separate castering assemblies consisting of at least two swivel assemblies each (total of at least four suitable duty swivel assemblies per rear axle). Each castering assembly is affixed to the rear brake drum or disc or directly to the suspensions (depending on a particular design) only by bolts normally affixing the wheel rim. There is no need for any stabilizer bracket because at least two swivel assemblies with pneumatic tires are spread apart, at least one in front of the rear axle and at least one behind the rear axle. This swivel assembly's distribution keeps the castering assembly in balance when placed in the driving position on the road surface. The at least double number of swiveling assemblies, self-balancing distribution of the swiveling assemblies and the lack of stabilizer bracket makes the embodiment no. 1 distinctive over the preferred apparatus disclosed in U.S. Pat. No. 5,626,362. Each castering assembly affixed in place of the corresponding rear wheel rotates freely, together with corresponding brake drum, in order to accommodate the balance changes caused by the bumpy road surface or the rear wheel load changes. The range of this rotation is limited by the condition of noninterference between any part of the vehicle and the castering assembly. There are positive stops provided for example on the inboard surface of each castering assembly. The swivels installed at the embodiment no. 1 are of suitable duty, 360 degrees turn, generally available at industrial supply store and equipped with suitable quality pneumatic tire. The swivel assembly is distinctive over prior art swivel by providing the vibration control device working continuously 360 degrees in-between two opposite, rotating parts of the swivel assembly. The vibration control device limits any higher-speed swivel wheel wobbling, when vibration control means, such as for example tension of the friction band, is adjusted. This embodiment is inexpensive, small, light and easy to install. Suitable for small and flat asphalt skid pads.
Embodiment No. 2 is a one axle, short, for example U-shaped, low floor trailer. This invention is distinctive over prior art skidding devices. The training vehicle rear wheels are not removed from the vehicle and are kept above the road surface throughout all training session. Both side swivel assemblies and the frame form one rigid and strong unit installed on the training vehicle as one piece. Embodiment no. 2 has a wide, light, tubular, 3-dimensional, for example U-shaped frame with two suitable duty swivel assemblies affixed to it (one on each end of the letter U) and a means to affix said frame to the training vehicle (for example an automotive trailer ball receiver in the center bottom of the U-shape). Each swivel assembly rotates freely 360 degrees and utilizes a generally available, suitable duty swivel with a distinctive leg arrangement. Using a single pneumatic wheel is possible, but twin pneumatic wheels with one center leg are preferred. To install the training vehicle on the embodiment no. 2, for example, back up the vehicle into the open side of the U-shaped frame. At the end of the backup both rear wheels will fall into corresponding cradles to the exact setting. Lift up the front of the trailer, place the vehicle's hitch into the vehicle's hitch receiver and affix it to the trailer ball receiver. The size and position of the cradle is made in the manner, that the corresponding rear wheel stays safely clear of the bumpy road surface throughout the training session. For each swivel assembly, a suitable duty vibration control device working continuously 360 degrees in-between two opposite rotating parts of the swivel assembly is provided. The vibration control device limits any higher-speed swivel wheel wobbling when vibration control means, such as for example pressure of the spring-loaded friction pad, is adjusted. Embodiment no. 2 is preferred. It is larger and heavier than embodiment no. 1, but not expensive considering its capabilities. It is safe at higher speeds and can be used over rough skid pads. The frame of the embodiment no. 2 can be made collapsible to the width allowed on the public highway in order to be pulled behind the training vehicle, as a utility trailer. This greatly improves system's transportability.
Embodiment No. 3 is a one axle, short, for example V-shaped, low floor trailer with an auxiliary wheel at the rear end. The addition of the swivel assemblies situated at both sides of the training vehicle, the frame connecting the swivel assembly behind the rear bumper of the training vehicle with both swivel assemblies situated at both sides of the training vehicle and resting of the training vehicle both rear wheels on the trailer's frame makes embodiment no. 3 distinctive over the alternate apparatus disclosed in U.S. Pat. No. 5,626,362. The weight distribution over entire system is superior to prior art. The training vehicle rear wheels are not removed from the vehicle and are kept above the road surface throughout all training session. Side swivel assemblies, rear auxiliary swivel assembly and the frame form one rigid and strong unit installed on the training vehicle as one piece. Embodiment no. 3 has a wide, light, tubular, 3-dimensional, for example V-shaped frame with three suitable duty swivel assemblies (one in each corner of the letter V) and means to affix said frame to the training vehicle (for example an automotive trailer ball receiver in the center of the V-shape). Each swivel assembly rotates freely 360 degrees and utilizes generally available suitable duty, swivel with a distinctive leg arrangement. Using a single pneumatic wheel is possible, but twin pneumatic wheels with one center leg are preferred. To install the training vehicle on the embodiment no. 3, for example, back up the vehicle into the open side of the V-shaped frame. At the end of the backup both rear wheels will fall into corresponding cradles to the exact setting. Lift up the rear of the trailer, place the vehicle's hitch into the vehicle's hitch receiver and affix it to the trailer ball receiver. The size and position of the cradle is made in the manner, that the corresponding rear wheel stays safely clear of the bumpy road surface throughout the training session. For each swivel assembly a suitable duty vibration control device working continuously 360 degrees in-between two opposite rotating parts of the swivel assembly is provided. The vibration control device limits any higher-speed swivel wheel wobbling when vibration control means, such as for example pressure of the spring-loaded friction pad, is adjusted. Embodiment no. 3 is safe at higher speeds and can be used over rough skid pads. Embodiment no. 3 has higher stability and load capacity. The frame of the embodiment no. 3 can be made collapsible to the width allowed on the public highway in order to be pulled behind the training vehicle, as a utility trailer. This greatly improves system's transportability.

### THE LIST OF DRAWINGS

Present invention is not limited to the precise arrangements and instrumentalities shown on the drawings. Some particularities are omitted for better clarity of the drawing. The drawings are solely for the purpose of illustrating the invention.

FIG. 01 is a schematic top view of the system embodiment no. 1 as installed on the training vehicle.

FIG. 02 is a schematic top view of the system embodiment no. 2 as installed on the training vehicle; location of the section shown in FIG. 12 is indicated.

FIG. 03 is a schematic top view of the system embodiment no. 3 as installed on the training vehicle.

FIG. 04 is a perspective view of the rear wheels subsystem embodiment no. 1 as installed on the training vehicle; right side castering assembly is only partially shown.

FIG. 05 is a perspective view of the rear wheels subsystem embodiment no. 2 preferred, as installed on the training vehicle; only a few particulars of the frame are shown for the drawing clarity reason.

FIG. 06 is a perspective view of the rear wheels subsystem embodiment no. 3 as installed on the training vehicle; only a few particulars of the frame are shown for the drawing clarity reason.

FIG. 07 is an outboard side view of the embodiment no. 1 castering assembly.

FIG. 08 is an inboard side view of the left side embodiment no. 1 castering assembly, as affixed to the left rear wheel; a part of wheel suspension and the brake drum are shown.

FIG. 09 is a side view of the exemplary swivel assembly with the vibration control device; this swivel assembly is utilized in embodiment no. 1, the location of the section shown in FIG. 10 is indicated.

FIG. 10 is a top view of the swivel assembly shown in FIG. 09, with section intended only to show the round outline of the swivel outer casing, the swivel is a generally available suitable duty type and in the hatched area contains a set of bearings, not shown on the drawing for the drawing clarity reason.

FIG. 11 is a partial perspective view of training vehicle left rear wheel placed in the corresponding cradle; the embodiment no. 2 frame is simplified and the swivel assembly is not shown on the drawing for the drawing clarity reason.

FIG. 12 is an inboard side view and section of the rear wheels subsystem embodiment no. 2 with the training vehicle affixed to it; only one wheel of the swivel assembly is shown for the drawing clarity reason, for the location of this section see FIG. 02.

FIG. 13 is a simplified side view of the embodiment no. 3 exemplary hook-up to the training vehicle.

FIG. 14 is a simplified side view of the embodiment no. 2 exemplary hook-up to the training vehicle.

FIG. 15 is a side view of the exemplary twin wheel, single leg, swivel assembly with the vibration control device; this swivel assembly is utilized in embodiment no. 2 and embodiment no. 3, the location of the section shown in FIG. 16 is indicated.

FIG. 16 is a top view of the swivel assembly shown in FIG. 15, with section intended only to show the round outline of the swivel outer casing, the swivel is a generally available suitable duty type and in the hatched area contains a set of bearings not shown on the drawing for the drawing clarity reason.

FIG. 17 is a side view of a generic swivel assembly; the drawing indicates the arrangement of the incline essential for swivel assemblies used in embodiment no. 1, 2&3, the front of the training vehicle is placed to the right of the drawing.

### DETAILED DESCRIPTION

At least one of two subsystems of the skid control training system is installed on a conventional front wheel drive automobile. They are namely: the front wheels selective braking subsystem and the rear wheels skid imitating subsystem.

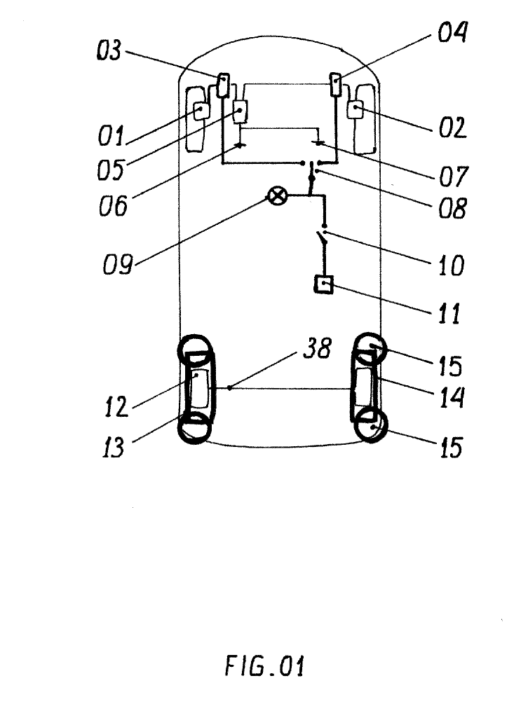

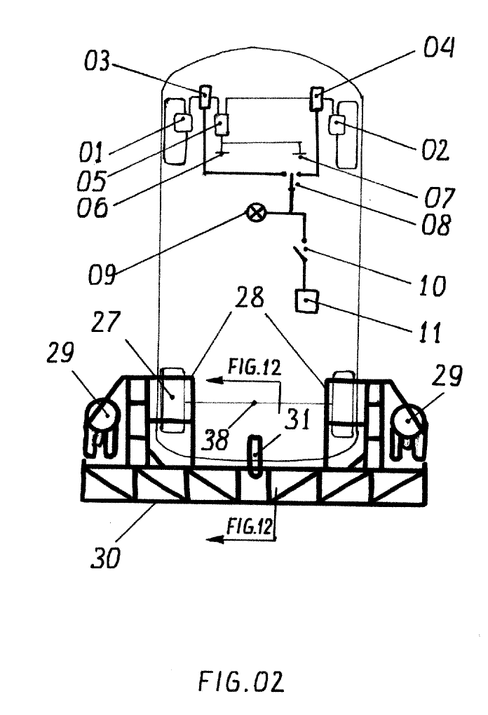

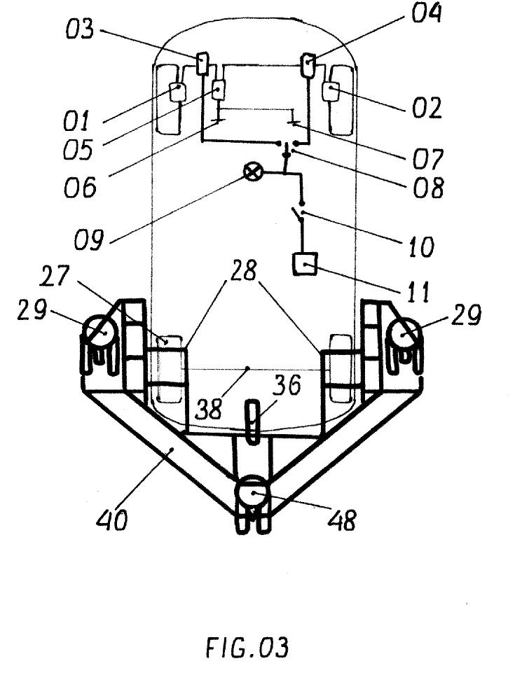

The front wheels selective braking subsystem is shown on drawings FIG. 01, FIG. 02 and FIG. 03. The subsystem starts for example with the power supply 11 connected to the input of the “system on/off” switch 10. The output of the switch 10 is connected to the “system on” indicator 09 and the input of the 3-way selection switch or set of switches 08.
The selection switch or set of switches 08 has for example one centrally located “off” position and two “on” spring-loaded, momentary outputs, one to the left and one to the right. The default position of the selection switch or set of switches 08 is always the central “off”. As an option, the selection switch or set of switches 08 can be replaced by, or supplemented by an electronic device randomly turning “on” only one of the two switch able outputs at any given moment in time. The switch able outputs of the selection switch or set of switches 08 are connected to the controlling inputs of the corresponding remote controlled cut off valves 03 and 04: one output to the controlling input of the valve 03 and another output to the controlling input of the valve 04.
The default position of the “normally open” valves 03 and 04 is “open” and they have to be activated to go into “closed” position. When deactivated valves 03 and 04 will automatically go back to the “open” position. The valve 03 exercises control over brake fluid flow or other means of breaking signal transmission in the vehicle brake system circuit, in-between the vehicle master cylinder 05 and the brake caliper 01. The valve 04 exercises control over brake fluid flow or other means of breaking signal transmission in the vehicle brake system circuit, in-between the vehicle master cylinder 05 and the brake caliper 02.
For example the brake caliper 01 controls left front wheel of the training vehicle and the brake caliper 02 controls right front wheel of the training vehicle. Closing the brake line leading from the master cylinder 05 to the caliper 01 will prompt lack of braking action of the front left wheel when vehicle brakes are applied. Closing the brake line leading from the master cylinder 05 to the caliper 02 will prompt lack of braking action of the front right wheel when vehicle brakes are applied.
The master cylinder 05 is activated by the vehicle's brake pedal 06. The auxiliary activator of the training vehicle brakes 07 can be located in the front passenger floor area and is connected to the vehicle's brake pedal 06. It is a standard arrangement on any driver-training vehicle and the driving instructor employs it to control the master cylinder 05.
Braking action in one front wheel only will prompt the yaw of the training vehicle to the opposite side. For example braking of the front right wheel only (when the front left brake line is closed by the valve 03) will prompt the yaw to the left. Braking of the front left wheel only will prompt the yaw to the right.
The selection circuit of the valves 03 and 04 containing for example but not limited to: valves 03 and 04, switches 08 and 10, indicator 09, power source 11 and the connecting means, can be made as electrical or electronic or fiber optic or hydraulic or pneumatic or mechanical or wireless or mixed.

The rear wheels skid imitating subsystem enables lateral movement of the rear of the training vehicle and has three distinct embodiments: no. 1, no. 2 and no. 3. The performance of all three embodiments is enhanced, when used together with the front wheels selective braking subsystem.

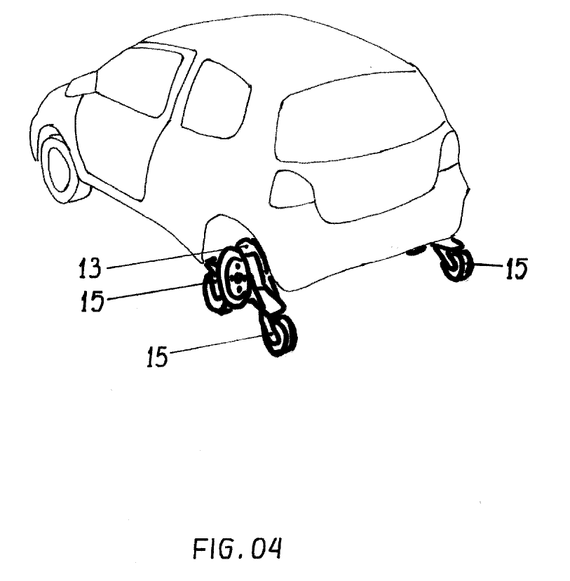

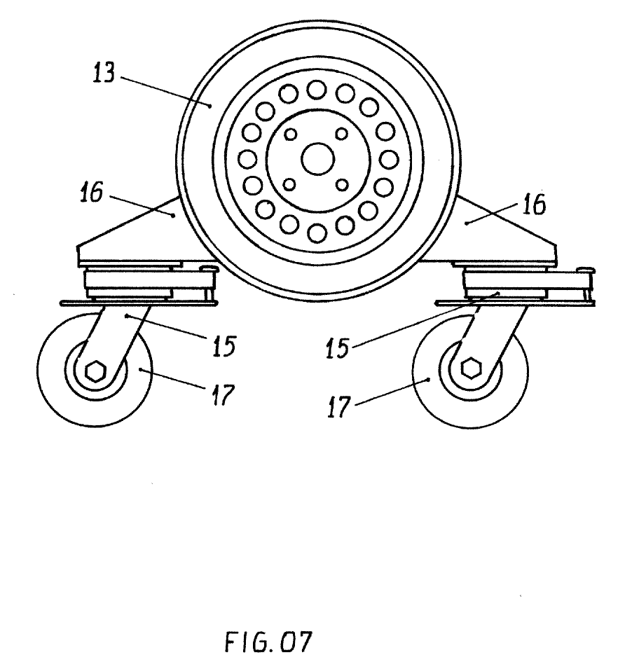

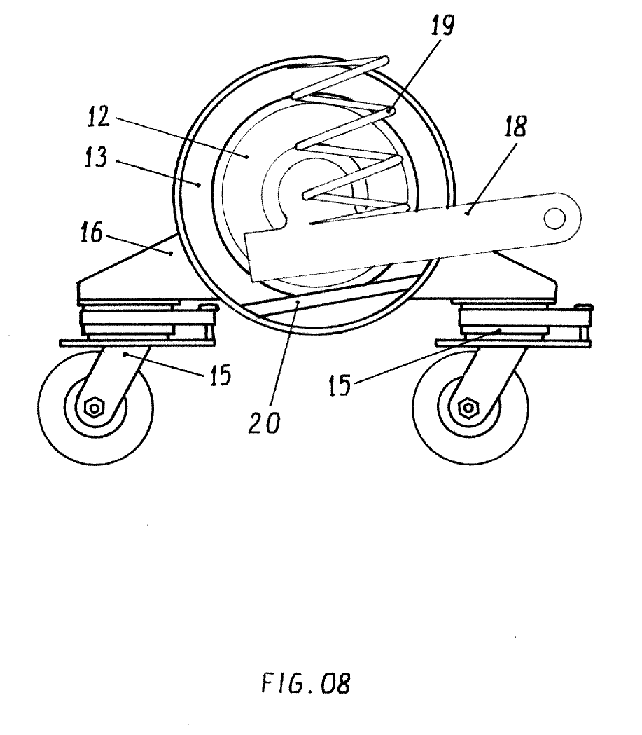

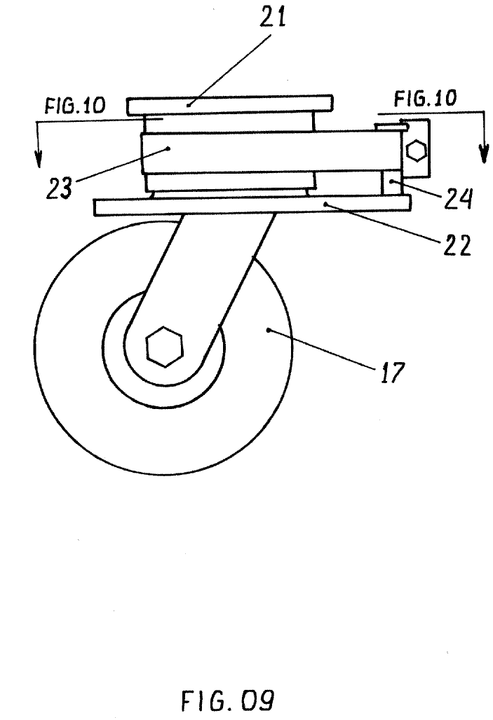

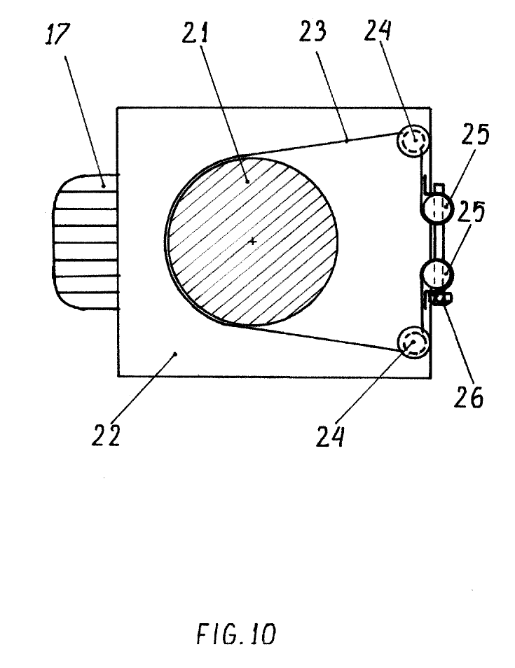

The rear wheels skid imitating subsystem embodiment no. 1 (called embodiment 1) is shown on drawings FIG. 01 and FIG. 04. It consists of two separate castering assemblies: the left castering assembly 13 is affixed in place of the rear left wheel to the rear left drum 12, and the right castering assembly 14 is affixed in place of the rear right wheel to the rear right drum. Each of the castering assemblies is affixed to the corresponding brake drum with the lug nuts or bolts, as the regular wheel would be affixed.
One possible design of the castering assembly 13 is shown on the drawing FIG. 07. There are two brackets 16 affixed to the wheel rim, one forward of the rim center and another bracket 16 rearward of the rim center. The brackets 16 are spread apart, as far as the wheel opening in the body allows for. There is one swivel assembly 15 affixed to each of the brackets 16.
Castering assembly 13 rotates freely around rear wheel axis in the range allowed by the rear wheel fender opening. The drawing FIG. 08 shows one of possible designs of a two-way stop bracket 20 provided for example on the inboard of the rim. Said stop bracket acts against the rocker arm 18 of the vehicle's rear axle suspension and limits the rotation of the castering assembly clockwise and counterclockwise. The accurate clockwise and counterclockwise limits have to be set in order to avoid interference between the castering assembly 13 and the training vehicle body parts.
The castering assembly 13 is balanced at any given time by the spread of the swivel assemblies 15 and does not require any stabilizer bracket. The clockwise and counterclockwise rotation of the castering assembly 13 is essential to compensate the castering assembly's balance, when wheels 17 go over bumpy road and the load transferred from the vehicles body by the spring element 19 and the rocker arm 18 fluctuates. Each of at least four per rear axle generally available suitable duty swivel assemblies 15 rotates freely 360 degrees around its swivel axis 50.
The pneumatic wheel 17 and a vibration control device shown on drawing FIG. 09 are essential improvements of each of the swivel assemblies 15. The vibration control device shown on drawing FIG. 09 utilize for example metal band 23 wrapped around the drum-like upper part of the swivel. The band 23 is spread over two pegs 24 and stretched for example by the bolt 26 and fasteners 25. The hatched part of the upper swivel 21, shown on the drawing FIG. 10, contains a set of bearings (not shown for the drawing clarity reason) allowing unobstructed rotation of the upper swivel 21 around the bottom base part 22.
The drawing FIG. 17 shows the incline 53 between the swivel rotation axis 50 and the vertical line 51, perpendicular to the road surface 52. The incline has to go down towards the front of the training vehicle and is measured after installation on the training vehicle.
To install the embodiment 1 on the training vehicle lift up the back of the vehicle and change rear wheels for the corresponding castering assemblies 13 and 14.

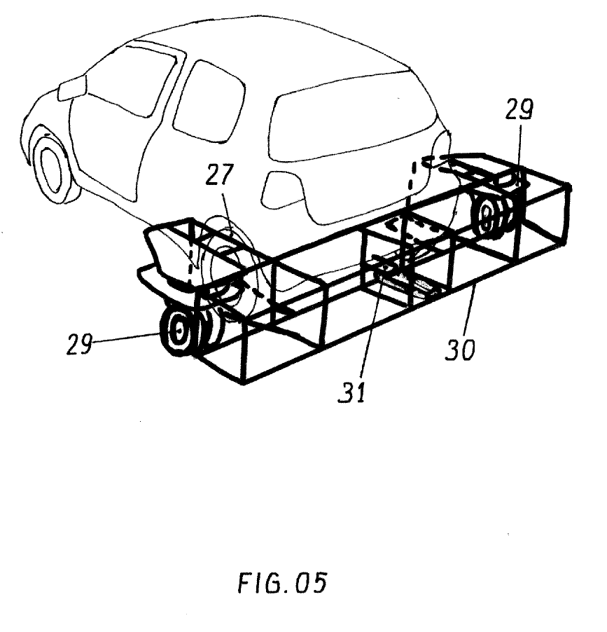

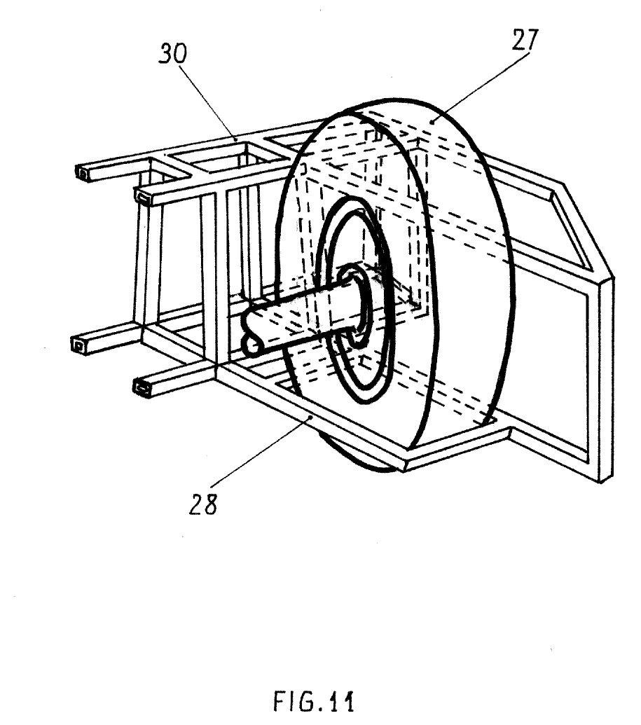

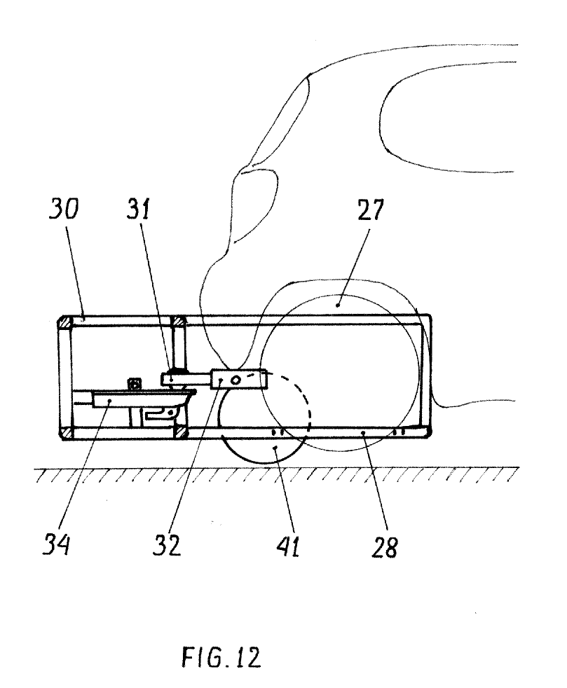

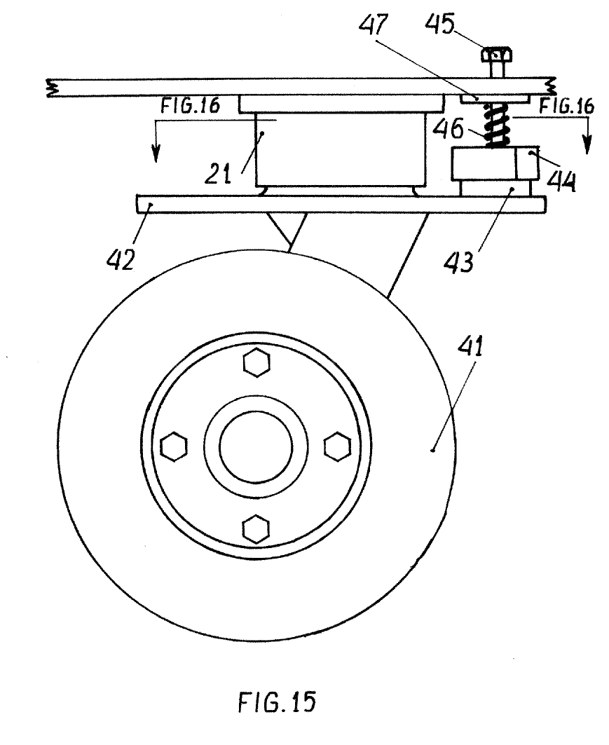

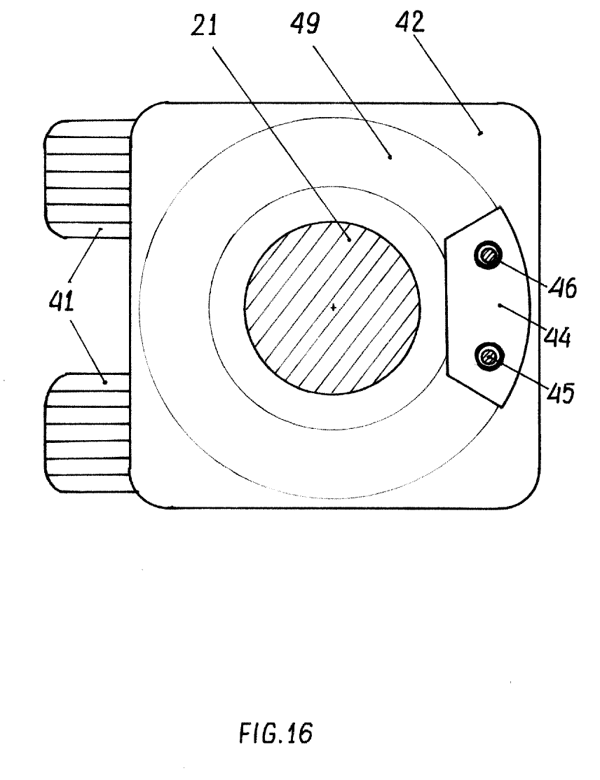

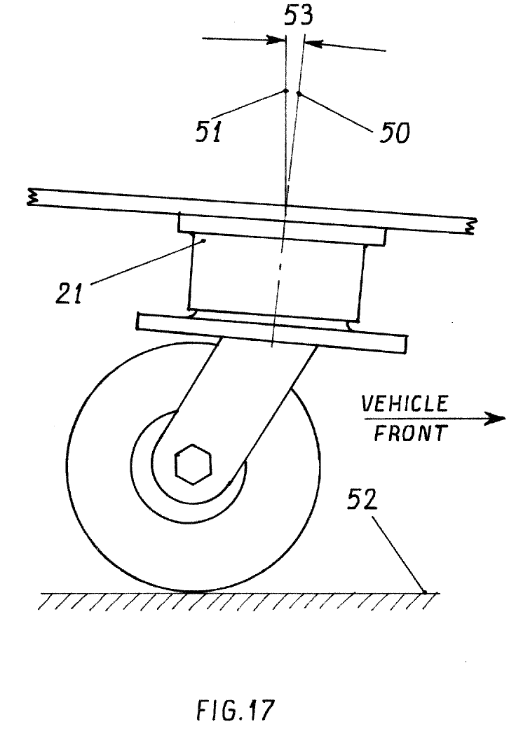

The rear wheels skid imitating subsystem embodiment no. 2 (called embodiment 2) is shown on drawings FIG. 02 and FIG. 05. This one axle trailer consists of a wide, rigid, 3-dimensional frame 30, with two built in wheel cradles 28, means to affix said frame to the training vehicle (for example an automotive trailer ball receiver 34 affixed to said frame) and two suitable duty swivel assemblies 29 affixed to said frame. The swivel assemblies shown for example on the drawing FIG. 15, each rotating freely 360 degrees around its swivel axis 50, can be used.
The twin pneumatic wheels 41 and a vibration control device shown on drawing FIG. 15 are the essential improvements of each of the swivel assemblies 29. The vibration control device shown on drawing FIG. 15 utilize for example a friction pad 43 pressed against the bottom part 42 of the swivel assembly 29. The pad 43 is placed for example in the holder 44 and pressed down by the spring 46 guided by the bolts 45. The washer 47 provides the spring pressure adjustment. The hatched part of the upper swivel 21, shown on the drawing FIG. 15, contains a set of bearings (not shown for a drawing clarity reason) allowing unobstructed rotation of the upper swivel 21 around the bottom base part 42. On the drawing FIG. 16 the round outline 49 shows the unobstructed, flat surface required for the friction pad 43 to work.
The drawing FIG. 17 shows the incline 53 between the swivel rotation axis 50 and the vertical line 51, perpendicular to the road surface 52. The incline has to go down towards the front of the training vehicle and is measured after installation on the vehicle.
Both rear wheels 27 of the training vehicle rest in the corresponding cradle 28, part of the frame 30, as shown on the drawing FIG. 11. The training vehicle is affixed to the embodiment 2; for example, by an automotive hitch 31 placed in the vehicle's hitch receiver 32. Shown on the drawing FIG. 14, the hitch ball 33 is placed in the automotive trailer ball receiver 34 affixed to frame 30. Shown on the drawing FIG. 12, the most forward location of the swivel wheels 41 center, is at or behind the center of the training vehicle rear wheels 27 (line 38 on FIG. 02). The trailer frame 30 and training vehicle rear wheels 27 cannot come in contact with the road surface throughout all training session.
To install the embodiment 2 on the training vehicle, for example, backup the rear wheels 27 of the vehicle into corresponding cradles 28 and lift up the front part of the embodiment 2 frame until the vehicle hitch receiver 32 is lined up above the trailer ball receiver 34. Place the hitch 31 in the vehicle's hitch receiver 32 with the ball 33 down and lower down the front part of the embodiment 2 frame until the ball 33 rests safely in the trailer ball receiver 34. See drawing FIG. 14.

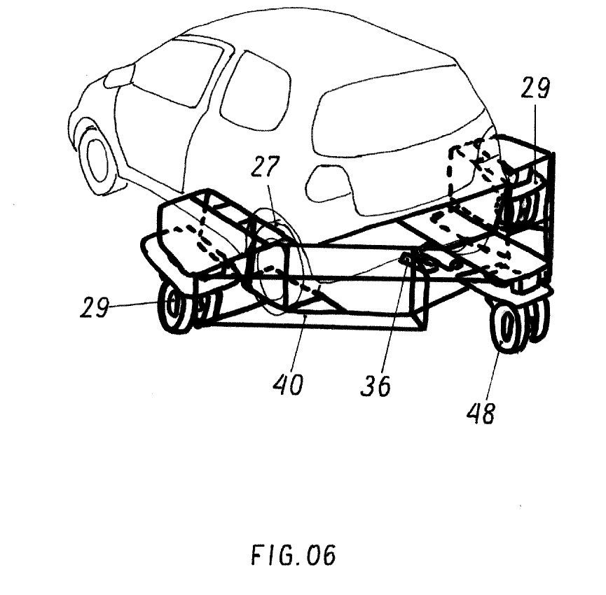

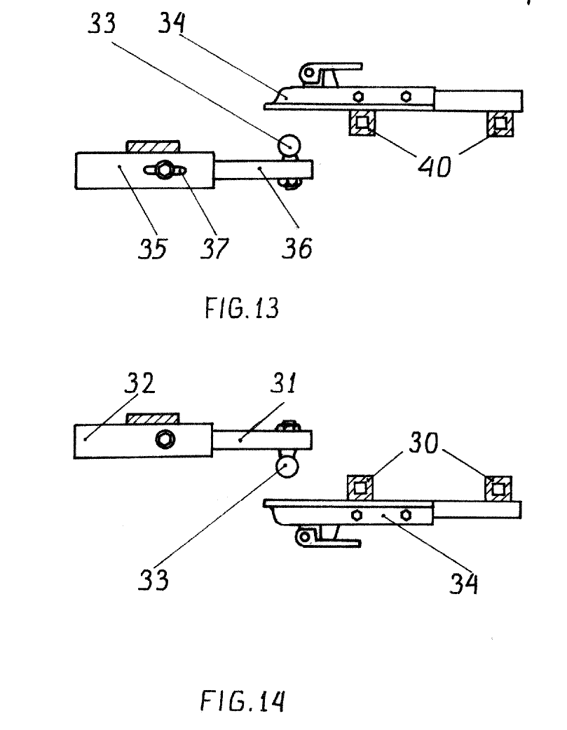

The rear wheels skid imitating subsystem embodiment no. 3 (called embodiment 3) is shown on drawings FIG. 03 and FIG. 06. This one axle trailer with an auxiliary rear swivel assembly 48 consists of a wide, rigid, 3-dimensional frame 40, with two built in wheel cradles 28, and means to affix it to the training vehicle (for example an automotive trailer ball receiver 34 affixed to said frame), and three suitable duty swivel assemblies affixed to said frame 40 (two side assemblies 29 and one rear assembly 48). The swivel assemblies shown for example on the drawing FIG. 15, each rotating freely 360 degrees around its swivel axis 50, can be used.
The twin pneumatic wheels 41 and a vibration control device shown on drawing FIG. 15 are the essential improvements of each of the swivel assemblies 29 and 48. The vibration control device shown on drawing FIG. 15 utilize for example a friction pad 43 pressed against the bottom part 42 of the swivel assembly 29. The pad 43 is placed for example in the holder 44 and pressed down by the spring 46 guided by the bolts 45. The washer 47 provides the spring pressure adjustment. The hatched part of the upper swivel 21, shown on the drawing FIG. 15, contains a set of bearings (not shown for the drawing clarity reason) allowing unobstructed rotation of the upper swivel 21 around the bottom base 42. On the drawing FIG. 16 the round outline 49 shows the unobstructed, flat surface required for the friction pad 43 to work.
The drawing FIG. 17 shows the incline 53 between the swivel rotation axis 50 and the vertical line 51, perpendicular to the road surface 52. The incline has to go down towards the front of the training vehicle and is measured after installation on the vehicle.
Both rear wheels 27 of the training vehicle rest in the corresponding cradle 28, part of the frame 40. It looks alike the resting position for embodiment 2 shown on the drawing FIG. 11. The training vehicle is affixed to the embodiment 3 by for example an automotive hitch 36 placed in the vehicle hitch receiver 35. Either the vehicle hitch receiver or the hitch is slotted 37. Shown on the drawing FIG. 13, the hitch ball 33 is placed in the automotive trailer ball receiver 34 affixed to the frame 40. The center of the training vehicle rear wheels 29 (line 38 on FIG. 03) is set in-between the most backward position of the side swivel wheels 29 and the auxiliary rear swivel wheel 48. The trailer frame 40 and the training vehicle rear wheels 27 cannot come in contact with the road surface throughout all training session.
To install the embodiment 3 on the training vehicle, for example, backup the rear wheels 27 of the vehicle into corresponding cradles 28 using a small, portable ramps. Lift up the rear part of the embodiment 3 until the vehicle hitch receiver 35 is lined up below the trailer ball receiver 34. Place the hitch 36 in the vehicle hitch receiver 35 with the ball 33 upright and lower down the rear part of the embodiment 3 until the ball 33 rests safely in the trailer ball receiver 34. See the drawing FIG. 13.

The primary intended use of the skid control training system is driving skills improvement activities for the automotive drivers. At the present time, skid control and skid recovery training is treated as a marginal activity available only at the high-end driver training facilities. This inexpensive invention will make the access to skid training possible and affordable for a wide multitude of drivers. The basic skid training activity for the driver includes driving the training vehicle equipped with the skid control training system on the course laid out with road pylons. The range of possible activities and skidding imitation capabilities are superior to the prior art systems. The skid control training system may be utilized by police departments, civic organizations or companies to demonstrate the effects of impaired driving, driving when under stress or fatigued, etc. This invention will be of use to film and entertainment industry to perform automobile acrobatics, stunts and film tricks or special effects.

What is claimed is:

1. The skid control training system comprises swivel assemblies swiveling freely 360 degrees, and means to affix said swivel assemblies to the body or frame or rear axle of an existing vehicle, and or control means through which a control can be exercised over the behavior of the wheels of an existing vehicle.

2. The skid control training system according to claim 1 comprises the control means through which control over front wheel brakes is affected, for example electric or electronic or fiber optic or wireless or hydraulic or pneumatic or mechanical or mixed circuit through which signals are send from human or computerized controller to the front wheel brakes and the feedback is send back to the controller.

3. The skid control training system according to claim 1 comprises the control means through which control over rear wheels setting is affected, for example a setup device restricting all except vertical travel of the rear wheels of the existing vehicle and preventing said rear wheels from coming in contact with the road surface.

4. The skid control training system according to claim 1 comprises two separate castering assemblies, one on each side of an existing vehicle, each of said castering assemblies comprises rigid casing affixed to the corresponding rear wheel brake drum or disc (depending on particular design) of the said vehicle and two or more swivel assemblies affixed to each rigid casing in the manner that at least one of said swivel assemblies is affixed to said casing forward of the axis of said rear brake drum or disc of said vehicle and at least one of said swivel assemblies is affixed to said casing rearward of the axis of said rear brake drum or disc of said vehicle, when said vehicle is placed on the horizontal surface in driving position with castering assemblies affixed to said vehicle.

5. The skid control training system according to claim 4 wherein said castering assembly includes rigid stops restricting clockwise and counter clockwise rotational movement of said castering assembly affixed to said brake drum or disc (depending on particular design), to the scope of non-interference of said castering assembly with any part of said vehicle.

6. The skid control training system according to claim 3 comprises a rigid frame with two setup devices affixed to said rigid frame, and means of affixing the said rigid frame to the body or frame of said existing vehicle, for example an automotive ball hitch receiver affixed to said rigid frame.

7. The skid control training system according to claim 6 wherein it further consists of two or more swivel assemblies affixed to said rigid frame in the manner that there is at least one swivel assembly on each side of said vehicle and all of said swivel assemblies are affixed to said rigid frame in the following zone: laterally outward from the rear wheels of said vehicle and longitudinally forward of the rear limit of said vehicle.

8. The skid control training system according to claim 7 wherein it further consists of one or more swivel assembly affixed to said rigid frame rearward of the rear limit of said vehicle.

9. The skid control training system wherein at least one of said swivel assemblies includes means of controlling vibrations of the swivel, for example vibration control device in form of brake pads, friction band or other means.
